(19) United States
(12) Patent Application Publication
(10) Pub. No.: US 2025/0336191 A1
(43) Pub. Date: Oct. 30, 2025

(54) EVALUATION OF MACHINE LEARNING SYSTEMS FOR THE SEMANTIC SEGMENTATION OF VIDEO DATA

(71) Applicant: Robert Bosch GmbH, Stuttgart (DE)

(72) Inventors: Maxim Tatarchenko, Berlin (DE); Ronny Xavier Velastegui Sandoval, Amsterdam (NL); Sezer Karaoglu, Amsterdam (NL); Theo Gevers, Amsterdam (NL)

(21) Appl. No.: 19/080,506

(22) Filed: Mar. 14, 2025

(30) Foreign Application Priority Data
Mar. 21, 2024 (DE) 10 2024 202 707.3

(51) Int. Cl. G06V 10/776; G06V 20/40

(52) U.S. Cl. CPC G06V 10/776; G06V 20/41

(57) ABSTRACT

A computer-implemented method for evaluating a machine learning system for semantic segmentation of video data. The method includes: video frames, segmentation frames for the video frames, and at least one target segmentation frame are provided for a video frame; a relative movement between a camera used to record the video data and the scene shown in the video frames is ascertained; an expected segmentation frame is ascertained from at least one segmentation frame using the ascertained relative movement; a ground truth consistency is ascertained that indicates the extent to which the actual segmentation frame, and/or the expected segmentation frame, is consistent with a predetermined target segmentation frame for the video frame; a temporal consistency is ascertained that indicates the extent to which pixels or other parts of the actual segmentation frame are consistent with corresponding pixels or other parts of the expected segmentation frame, or the actual segmentation frame.

### FIELD

The present invention relates to the semantic segmentation of video data that can be used, for example, for environmental monitoring of automatically controlled vehicles and/or robots.

### BACKGROUND INFORMATION

The at least partially automated driving of vehicles and/or robots on company premises or in public road traffic requires constant monitoring of the environment of this vehicle and/or robot. For this purpose, in particular, one or more cameras are used to provide sequences of video frames.

The analysis of these video frames can in particular comprise semantic segmentation, which assigns a class, such as an object type, to pixels or other parts of the particular frame. With such semantic segmentation, the scenery shown in the video frames can be converted into a machine-readable form that can be used by downstream systems, such as a trajectory planner. In this way, for example, the trajectory of the vehicle or robot can be planned to avoid collisions with other objects.

It is important that the semantic segmentation is temporally consistent. For example, it is not plausible that the same object that is visible in two consecutive video frames would be assigned to different classes based on these two video frames.

### SUMMARY

The present invention provides a computer-implemented method for evaluating a machine learning system for semantic segmentation of video data. These video data contain video frames X₁, X₂, . . . , X_{N} that were recorded in a time-discrete sequence. The semantic segmentation is sufficient for a predetermined horizon of t time steps into the future and thus comprises segmentation frames Y₁, Y₂, . . . , Yₜ₋₁, Yₜ where t≤N. Each such segmentation frame Y₁, Y₂, . . . , Yₜ₋₁, Yₜ assigns pixels or other parts of the relevant video frame X₁, X₂, . . . , Xₜ₋₁, Xₜ a class from a predetermined classification.

According to an example embodiment of the present invention, as part of the method, video frames X₁, X₂, . . . , Xₜ₋₁, Xₜ and segmentation frames Y₁, Y₂, . . . , Yₜ₋₁, Yₜ ascertained by the machine learning system for said video frames are provided. Furthermore, at least one target segmentation frame Sₜ is provided for a video frame Xₜ. The target segmentation frame Sₜ is the segmentation frame Yₜ that the machine learning system should ideally provide for the video frame Xₜ. It is therefore also referred to as “ground truth.”

A relative movement between a camera used to record the video data and the scene shown in the video frames X₁, X₂, . . . , X_{N} is ascertained. This relative movement can be composed in any way from movements of the camera on the one hand and movements in the scenery on the other. For example, it can be expressed, without limiting the generality, by the fact that the pose, i.e., the combination of pose and orientation, of the camera changes from frame to frame relative to a scene at rest.

An expected segmentation frame Ŷₜ is ascertained from at least one segmentation frame Yₜ₋₁ using the ascertained relative movement. This expected segmentation frame Yₜ is therefore the segmentation frame that should be created when the video frame only changes due to the relative movement between the camera and the scenery in the time step from t−1 to t. Ascertaining the expected segmentation frame Ŷₜ can in particular include, for example, distorting (warping) the segmentation frame Yₜ₋₁ based on the ascertained relative movement. That is, the information contained in the segmentation frame Yₜ₋₁ that is shown from the perspective of a camera pose at the time t−1, is shown in the expected segmentation frame Ŷₜ from the perspective of a camera pose at the time t. In real video sequences, perfect temporal consistency is usually not to be expected, since the expected segmentation frame Ŷₜ does not take into account the fact that, for example,
objects from the perspective of the two camera poses can be covered (occluded) by other objects to varying degrees and
objects between the times t−1 and t can appear in or disappear from the scene (such as a person getting out of or into a vehicle).

Furthermore, ground truth consistency is also ascertained. This ground truth consistency indicates the extent to which the actual segmentation frame Yₜ, and/or the expected segmentation frame Ŷₜ, is consistent with a predetermined target segmentation frame Sₜ for the video frame Xₜ.

A temporal consistency is now ascertained only for the pixels or other parts of the actual segmentation frame Yₜ for which this ground truth consistency is given. This temporal consistency indicates the extent to which these pixels or other parts are consistent with corresponding pixels or other parts of the expected segmentation frame Ŷₜ. Conversely, all pixels or other parts of the actual segmentation frame Yₜ for which no ground truth consistency is given are not included in the ascertainment of temporal consistency.

Alternatively, according to an example embodiment of the present invention, starting from the pixels or other parts of the actual segmentation frame Yₜ for which ground truth consistency is given, the corresponding pixels or other parts of the expected segmentation frame Ŷₜ can be analyzed with regard to temporal consistency. Then the actual segmentation frame Yₜ can remain unchanged. Instead, pixels or other parts are extracted only from the expected segmentation frame Ŷₜ.

The desired evaluation of the machine learning system is analyzed from the temporal consistency.

It has been recognized that limiting the ascertainment of temporal consistency to pixels or other parts for which ground truth consistency is also present leads to more accurate measurement of the performance of the machine learning system. In particular, this limitation prevents the creation of perverse incentives for the development of the machine learning system when the machine learning system is trained using the evaluation ascertained by the method as feedback. If only temporal consistency were considered during the evaluation, the machine learning system could, in extreme cases, fraudulently obtain a good evaluation by simply throwing out the same segmentation frame for all video frames, for example in the form of a homogeneous area that fills the entire frame and is assigned to a certain class. In this case, maximum temporal consistency is always achieved, but the result no longer has anything to do with the actual semantic content of the video data.

It was further recognized that, during the training of the machine learning system, the video sequences used as training examples of video frames X₁, X₂, . . . , Xₜ₋₁, Xₜ can differ from one another in terms of their usefulness and meaningfulness. For example, the training examples can comprise video sequences recorded during the day and in good visibility conditions, so that content is clearly recognizable throughout the entire frame. Conversely, there can also be video sequences in which only individual contents are recognizable and the majority of the frames are not usable for further analysis. By determining temporal consistency only for the semantically correctly analyzable pixels or other parts, an evaluation ascertained on the basis of a video sequence can, for example, be weighted with the quantity of pixels or other parts for which ground truth consistency is given.

In a particularly advantageous embodiment of the present invention, the ground truth consistency is ascertained as the ground truth consistency set of the pixels or other parts of the actual segmentation frame Yₜ, Yₜ, and/or the expected segmentation frame Ŷₜ, that, together with corresponding pixels or other parts of the target segmentation frame Sₜ, satisfy a predetermined consistency criterion. The consistency criterion can, for example, specify that pixels or other parts of the actual segmentation frames Yₜ may deviate only by certain amounts from the corresponding pixels or other parts of the target segmentation frame Sₜ. The cardinality of the ground truth consistency set then provides information about the degree of ground truth consistency for the training example as a whole. Thus, it is particularly advantageous to use the cardinality of the ground truth consistency set to ascertain a measure of ground truth consistency for the training example consisting of video frames X₁, X₂, . . . , X_{N} and target segmentation frames Sₜ.

In a further particularly advantageous embodiment of the present invention, the temporal consistency is ascertained for the pixels or other parts of the ground truth consistency set. In this way, the pixels or other parts for which the semantic segmentation is not meaningful can be excluded from the ascertainment of temporal consistency from the outset. The computational effort required for this can therefore be completely saved compared to a solution in which the temporal consistency is first calculated for all pixels or other parts and then subsequently discarded for the non-meaningful pixels or other parts.

For example, the test for temporal consistency can be fed an element-wise product of the actual segmentation frame Yₜ having a binary mask that indicates whether a pixel or other part of the actual segmentation frame Yₜ belongs to the ground truth consistency set. The test for temporal consistency can then be implemented with fast matrix operations, which are much more efficient than treating the individual pixels or other parts one after the other. Nevertheless, unnecessary effort for the treatment of non-meaningful pixels or other parts can still be avoided.

In a further particularly advantageous embodiment of the present invention, the temporal consistency is ascertained as the time consistency set of the pixels or other parts of the actual segmentation frame Yₜ that, together with corresponding pixels or other parts of the expected segmentation frame Ŷₜ, satisfy a predetermined consistency criterion. Alternatively, the pixels or other parts of the expected segmentation frame Ŷₜ that, together with corresponding pixels or other parts of the actual segmentation frame Yₜ, satisfy a consistency criterion, can also be ascertained. Both approaches provide a direct statement about the spatial regions of the actual segmentation frame Yₜ in which temporal consistency is present and in which it is not. At the same time, the cardinality of the time consistency set can be seen overall as an indicator for the degree of temporal coherence for the time step from t−1 to t.

Thus, the desired evaluation of the machine learning system is particularly advantageously analyzed based on the cardinality of the time consistency set. For example, the evaluation can be described as a kind of “mean Intersection over Union” (mIoU) between the part of the expected segmentation frame Ŷₜ for which ground truth consistency is given on the one hand and the actual segmentation frame Yₜ on the other hand: The intersection between the two corresponds to the time consistency set. In the mIoU calculation, the cardinality of this intersection is divided by the cardinality of the union, i.e., in this case the set of all pixels of the frame. The “mean” refers to the fact that this calculation is performed separately for all classes and the results are averaged.

In a further particularly advantageous example embodiment of the present invention, the evaluation of the machine learning system is used as feedback for the optimization of parameters that characterize the behavior of the machine learning system. By better matching the evaluation of the machine learning system to its actual performance, training is more likely to be steered in the direction of real improvement. In particular, as explained above, no perverse incentives are created for the further development of the machine learning system.

In a further particularly advantageous example embodiment of the present invention, the ascertained evaluation of the machine learning system is assigned to segmentation frames Y₁, Y₂, Yₜ₋₁, Yₜ provided by this machine learning system as confidences. In this way, during further processing of these segmentation frames Y₁, Y₂, . . . , Yₜ₋₁, Yₜ it is possible to take into account how good the overall training state of the machine learning system was. For example, if the segmentation frames Y₁, Y₂, . . . , Yₜ₋₁, Yₜ are merged with segmentation frames from other sources, they can be weighted as confidences with the evaluation ascertained according to the method proposed here.

Alternatively, or in combination herewith, according to an example embodiment of the present invention, the machine learning system can be approved for use in response to the ascertained evaluation exceeding a predetermined threshold. This can be used, for example, as an abort criterion for training the machine learning system.

In a further particularly advantageous example embodiment of the present invention, video frames X₁, X₂, . . . , Xₜ₋₁, Xₜ are fed to the trained machine learning system that were recorded using at least one camera. A control signal is ascertained from the semantic segmentation frames Y₁, Y₂, . . . , Yₜ₋₁, Yₜ subsequently provided by the machine learning system. A vehicle, a driver assistance system, a robot, a system for quality control, a system for monitoring regions, and/or a system for medical imaging is controlled with the control signal. In this context, the improved training due to the more accurate evaluation of the actual performance of the machine learning system has the effect that the response of the controlled system to the control signal is more likely to be appropriate to the situation embodied in the sequence of video frames X₁, X₂, . . . , Xₜ₋₁, Xₜ.

The method can in particular be wholly or partially computer-implemented. The present invention therefore also relates to a computer program comprising machine-readable instructions that, when executed on one or more computers and/or compute instances, cause the computer(s) and/or compute instance(s) to execute the described method of the present invention. In this sense, control devices for vehicles and embedded systems for technical devices, which are also capable of executing machine-readable instructions, are also to be regarded as computers. Compute instances can be virtual machines, containers or serverless execution environments, for example, which can be provided in a cloud in particular.

The present invention also relates to a machine-readable data carrier and/or to a download product comprising the computer program of the present invention. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present invention are explained in more detail below, together with the description of the preferred exemplary embodiments of the present invention, with reference to the figures.

### BRIEF DESCRIPTION OF THE DRAWINGS

FIG. 1A shows an exemplary embodiment of the method 100 for evaluating a machine learning system 1 for the semantic segmentation of video data, according to the present invention.

FIG. 1B shows an exemplary embodiment of the method 100 for evaluating a machine learning system 1 for the semantic segmentation of video data, according to the present invention.

FIG. 2 shows an example of a processing operation of video frames Xₜ₋₁, Xₜ for evaluation 5, according to the present invention.

FIG. 3A-3D shows examples of segmentation frames Yₜ₋₁, Yₜ having different ground truth consistencies that are included in the evaluation 5.

### DETAILED DESCRIPTION OF EXAMPLE EMBODIMENTS

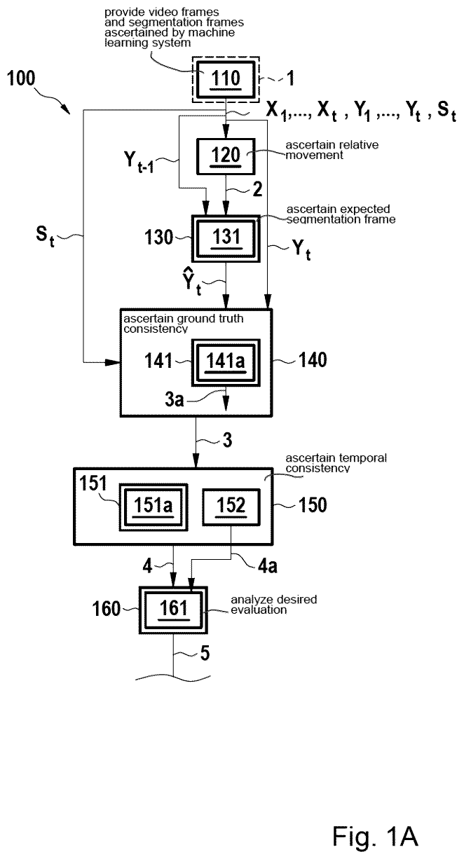

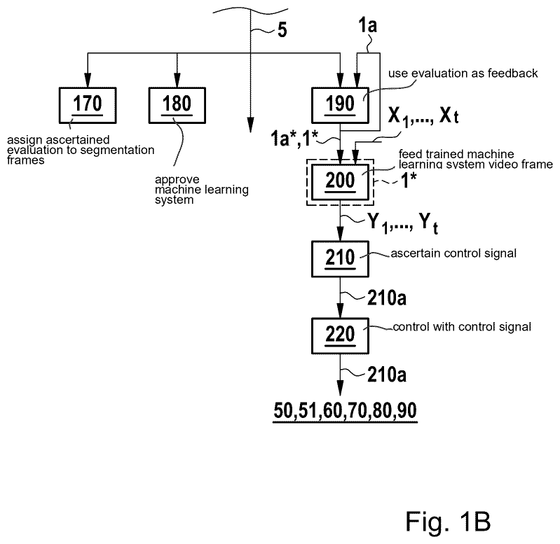

FIG. 1 is a schematic flowchart of an exemplary embodiment of the method 100 for evaluating a machine learning system 1 for semantic segmentation of video data. The video data contain video frames X₁, X₂, . . . , X_{N}. The semantic segmentation comprises segmentation frames Y₁, Y₂, . . . , Yₜ₋₁, Yₜ where t≤N. These segmentation frames Y₁, Y₂, . . . , Yₜ₋₁, Yₜ assign pixels or other parts of the particular video frame X₁, X₂, . . . , Xₜ₋₁, Xₜ a class from a predetermined classification.

In step 110, video frames X₁, X₂, . . . , Xₜ₋₁, Xₜ and segmentation frames Y₁, Y₂, . . . , Yₜ₋₁, Yₜ ascertained by machine learning system 1 for said video frames are provided. Furthermore, at least one target segmentation frame Sₜ is provided for a video frame Xₜ.

In step 120, a relative movement 2 between a camera used to record the video data and the scene shown in the video frames X₁, X₂, . . . , X_{N} is ascertained.

In step 130, an expected segmentation frame Ŷₜ is ascertained from at least one segmentation frame Yₜ₋₁ using the ascertained relative movement 2.

According to block 131, ascertaining the expected segmentation frame Ŷₜ can include distorting the segmentation frame Yₜ₋₁ based on the ascertained relative movement 2.

In step 140, a ground truth consistency 3 is ascertained that indicates the extent to which the actual segmentation frame Yₜ, and/or the expected segmentation frame Ŷₜ, is consistent with a predetermined target segmentation frame Sₜ for the video frame Xₜ.

According to block 141, the ground truth consistency 3 can be ascertained as the ground truth consistency set 3a of the pixels or other parts of the actual segmentation frame Yₜ, and/or the expected segmentation frame Ŷₜ, that, together with corresponding pixels or other parts of the target segmentation frame Sₜ, satisfy a predetermined consistency criterion.

According to block 141a, based on the cardinality of the ground truth consistency set 3a, a measure of ground truth consistency for the training example consisting of video frames X₁, X₂, . . . , X_{N} and target segmentation frames Sₜ can be ascertained.

In step 150, for the pixels or other parts of the actual segmentation frame Yₜ for which this is the case, or for corresponding pixels or other parts of the expected segmentation frame Ŷₜ, a temporal consistency 4 is ascertained. This temporal consistency 4 indicates the extent to which these pixels or other parts are consistent with corresponding pixels or other parts of the expected segmentation frame Ŷₜ or the actual segmentation frame Yₜ.

According to block 151, the temporal consistency 4 can be ascertained for the pixels or other parts of the ground truth consistency set 3a.

According to block 151a, the test for temporal consistency can be fed an element-wise product of the actual segmentation frame Yₜ having a binary mask that indicates whether a pixel or other part of the actual segmentation frame Yₜ belongs to the ground truth consistency set 3a.

According to block 152, the temporal consistency 4 can be ascertained as the time consistency set 4a of the pixels or other parts of the actual segmentation frame Yₜ, or of the expected segmentation frame Ŷₜ, that, together with corresponding pixels or other parts of the expected segmentation frame Ŷₜ, or of the actual segmentation frame Yₜ, satisfy a predetermined consistency criterion.

In step 160, the desired evaluation 5 of the machine learning system 1 is analyzed from the temporal consistency 4. Insofar as the temporal consistency 4 is present as a time consistency set 4a according to block 152, the desired evaluation 5 of the machine learning system 1 can be analyzed according to block 161 based on the cardinality of the time consistency set 4a.

The ascertained evaluation 5 of the machine learning system 1 can be assigned (step 170) to segmentation frames Y₁, Y₂, . . . , Yₜ₋₁, Yₜ provided by this machine learning system 1 as confidences. Alternatively or in combination herewith, the machine learning system 1 can be approved for use (step 180) in response to the ascertained evaluation 5 exceeding a predetermined threshold.

In step 190, the evaluation 5 of the machine learning system can be used as feedback for the optimization of parameters 1a that characterize the behavior of the machine learning system 1. The fully optimized state of the parameters 1a is denoted by reference sign 1a* and also defines the fully trained state 1* of the machine learning system 1.

In step 200, the trained machine learning system 1* can be fed video frames X₁, X₂, . . . , Xₜ₋₁, Xₜ that were recorded using at least one camera. Then, in step 210, a control signal 210a can be ascertained from the semantic segmentation frames Y₁, Y₂, . . . , Yₜ₋₁, Yₜ subsequently provided by the machine learning system 1. In step 220, a vehicle 50, a driver assistance system 51, a robot 60, a system 70 for quality control, a system 80 for monitoring regions, and/or a system 90 for medical imaging can then be controlled with the control signal 210a.

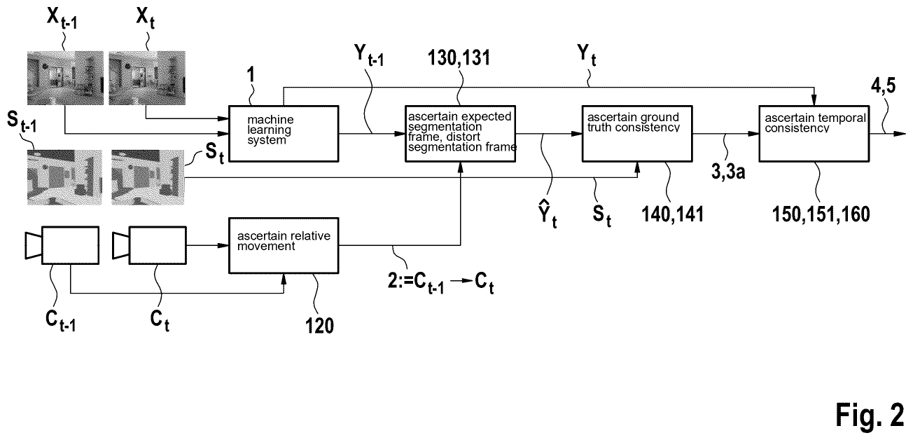

FIG. 2 illustrates an example of a processing operation of video frames Xₜ₋₁, Xₜ for evaluation 5.

In the example shown in FIG. 2, there is a video sequence having video frames X₁, X₂, . . . , Xₜ₋₁, Xₜ, of which only Xₜ₋₁ and Xₜ are shown. Target segmentation frames Sₜ₋₁ and Sₜ are available for these video frames Xₜ₋₁ and Xₜ. The two video frames Xₜ₋₁ and Xₜ differ, among other things, in the poses Cₜ₋₁ or Cₜ of the camera used for recording relative to the scenery. The relative movement 2, which represents the difference between these poses Cₜ₋₁ and Cₜ, is ascertained in step 120 of the method 100.

The machine learning system 1 ascertains a segmentation frame Yₜ₋₁ for the video frame Xₜ₋₁ and a segmentation frame Yₜ for the video frame Xₜ. With the relative movement 2, in step 130 of the method 100 and according to block 131, an expected segmentation frame Ŷₜ is ascertained from the segmentation frame Yₜ by distortion. In step 140 and according to block 141, it is ascertained which part of this expected segmentation frame Ŷₜ is consistent with the target segmentation frame Sₜ for the time t. The ground truth consistency 3 is passed on in the form of a ground truth consistency set 3a of those pixels for which consistency is given.

In step 150 and according to block 151, it is ascertained only for the pixels that are part of the ground truth consistency set 3a to what extent these pixels are consistent with corresponding pixels of the actual segmentation frame Yₜ. The desired evaluation 5 of the machine learning system is then analyzed herefrom in step 160.

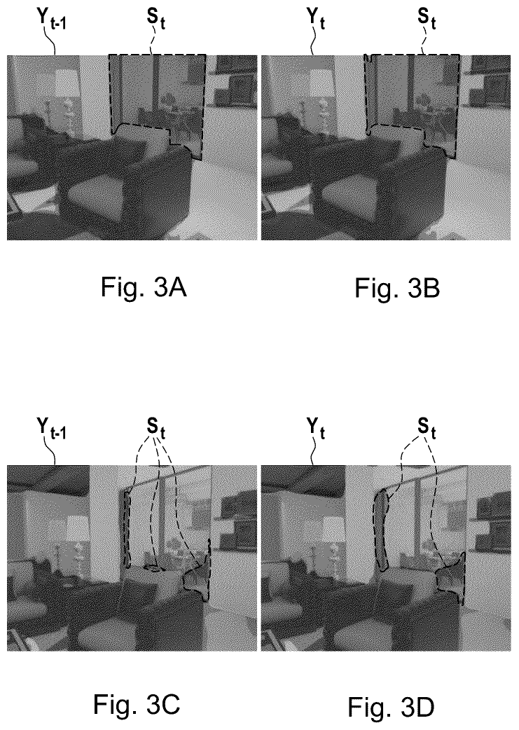

FIG. 3A-3D illustrates how a different match of segmentation frames Yₜ₋₁ and Yₜ with associated target segmentation frames Sₜ₋₁ and Sₜ affects the evaluation 5 of the machine learning system 1 ascertained according to the method proposed here.

The partial images in FIGS. 3A and 3B relate to a first pair of times t−1 on the one hand and t on the other hand, and thus also to a first pair of camera poses Cₜ₋₁ on the one hand and Cₜ on the other hand. The partial images in FIGS. 3C and 3D relate to a second pair of times t−1 on the one hand and t on the other hand, and thus also to a second pair of camera poses Cₜ₋₁ on the one hand and Cₜ on the other hand.

The pure temporal consistency between the segmentation frame Yₜ₋₁ shown in the partial image in FIG. 3A and the segmentation frame Yₜ shown in the partial image in FIG. 3B is 0.909. The change in the segmentation frames therefore corresponds substantially to what is to be expected due to the different camera poses Cₜ₋₁ and Cₜ.

The segmentation frame Yₜ₋₁ shown in the partial image in FIG. 3A has a similarity measured by “mean Intersection over Union” (mIoU) to the corresponding target segmentation frame Sₜ₋₁ of 0.911. For the segmentation frame Yₜ shown in the partial image in FIG. 3B, the similarity to the target segmentation frame Sₜ is 0.899.

According to the method proposed here, only the portion of the segmentation frames Yₜ₋₁ and Yₜ for which ground truth consistency 3 exists at all is included in the evaluation 5 of the machine learning system via the temporal consistency 4. In the example of the partial images in FIGS. 3A and 3B, this evaluation 5 results in a good value of 0.848.

In contrast to this example, the segmentation frames Yₜ₋₁ and Yₜ shown in the partial images in FIGS. 3C and 3D only have mIoU similarities of 0.431 and 0.436 with the respective target segmentation frames Sₜ₋₁ or Sₜ. As shown in FIG. 3, the reason for this lies in particular in a large window area in the living room shown, which was not correctly recognized by the machine learning system 1.

A conventional evaluation of the machine learning system 1 based solely on the temporal consistency 4 would still result in a good value of 0.826. However, according to the method proposed here, it is taken into account that the window area is almost completely excluded from this evaluation and the temporal consistency 4 is ascertained on a much thinner basis. Therefore, the evaluation 5 ascertained using this method only comes to a value of 0.401.

1-14. (canceled)

15. A computer-implemented method for evaluating a machine learning system for semantic segmentation of video data containing video frames X₁, X₂, . . . , X_{N}, wherein the semantic segmentation includes actual segmentation frames Y₁, Y₂, . . . , Yₜ₋₁, Yₜ where t≤N that assign pixels or other parts of each particular video frame X₁, X₂, . . . , Xₜ₋₁, Xₜ a class from a predetermined classification, the method comprising the following steps:
providing video frames X₁, X₂, . . . , Xₜ₋₁, Xₜ, segmentation frames Y₁, Y₂, . . . , Yₜ₋₁, Yₜ ascertained by the machine learning system for the video frames X₁, X₂, . . . , Xₜ₋₁, Xₜ, and at least one target segmentation frame Sₜ for a video frame Xₜ;
ascertaining a relative movement between a camera used to record the video data and the scene shown in the video frames X₁, X₂, . . . , X_{N};
ascertaining an expected segmentation frame Ŷₜ from at least one segmentation frame Yₜ₋₁ using the ascertained relative movement;
ascertaining a ground truth consistency that indicates an extent to which the actual segmentation frame Yₜ, and/or the expected segmentation frame Ŷₜ, is consistent with the target segmentation frame Sₜ for the video frame Xₜ;
for pixels or other parts of the actual segmentation frame Yₜ for which consistency exists, or for corresponding pixels or other parts of the expected segmentation frame Ŷₜ, ascertaining a temporal consistency that indicates the extent to which the pixels or other parts are consistent with corresponding pixels or other parts of the expected segmentation frame Ŷₜ, or the actual segmentation frame Yₜ; and
analyzing a desired evaluation of the machine learning system from the temporal consistency.

16. The method according to claim 15, wherein the ground truth consistency is ascertained as a ground truth consistency set of the pixels or other parts of the actual segmentation frame Yₜ and d/or the expected segmentation frame Ŷₜ, that, together with corresponding pixels or other parts of the target segmentation frame Sₜ, satisfy a predetermined consistency criterion.

17. The method according to claim 16, wherein, based on a cardinality of the ground truth consistency set, a measure of ground truth consistency for a training example including the video frames X₁, X₂, . . . , X_{N} and the target segmentation frame Sₜ is ascertained.

18. The method according to claim 17, wherein the temporal consistency is ascertained for pixels or other parts of the ground truth consistency set.

19. The method according to claim 18, wherein a test for temporal consistency is fed an element-wise product of the actual segmentation frame Yₜ having a binary mask that indicates whether a pixel or other part of the actual segmentation frame Yₜ belongs to the ground truth consistency set.

20. The method according to claim 15, wherein the temporal consistency is ascertained as a time consistency set of the pixels or other parts of the actual segmentation frame Yₜ, or of the expected segmentation frame Ŷₜ, that, together with corresponding pixels or other parts of the expected segmentation frame Ŷₜ, or the actual segmentation frame Yₜ, satisfy a predetermined consistency criterion.

21. The method according to claim 20, wherein the desired evaluation of the machine learning system is analyzed based on a cardinality of the time consistency set.

22. The method according to claim 15, wherein the ascertaining of the expected segmentation frame Ŷₜ includes distorting the actual segmentation frame Yₜ₋₁ based on the ascertained relative movement.

23. The method according to claim 15, wherein:
the ascertained evaluation of the machine learning system is assigned to the actual segmentation frames Y₁, Y₂, . . . , Yₜ₋₁, Yₜ provided by the machine learning system as confidences, and/or
the machine learning system is approved for use in response to the ascertained evaluation exceeding a predetermined threshold.

24. The method according to claim 15, wherein the evaluation of the machine learning system is used as feedback for an optimization of parameters that characterize a behavior of the machine learning system.

25. The method according to claim 24, wherein:
the trained machine learning system is fed video frames that were recorded using at least one camera,
a control signal is ascertained from semantic segmentation frames subsequently provided by the machine learning system, and
a vehicle and/or a driver assistance system and/or a robot and/or a system for quality control and/or a system for monitoring regions and/or a system for medical imaging, is controlled with the control signal.

26. A non-transitory machine-readable data carrier on which is stored a computer program including machine-readable instructions for evaluating a machine learning system for semantic segmentation of video data containing video frames X₁, X₂, . . . , X_{N}, wherein the semantic segmentation includes actual segmentation frames Y₁, Y₂, . . . , Yₜ₋₁, Yₜ where t≤N that assign pixels or other parts of each particular video frame X₁, X₂, . . . , Xₜ₋₁, Xₜ a class from a predetermined classification, the instructions, when executed on one or more computers and/or computer instances, causing the one or more computers and/or computer instances to perform the following steps:
providing video frames X₁, X₂, . . . , Xₜ₋₁, Xₜ, segmentation frames Y₁, Y₂, . . . , Yₜ₋₁, Yₜ ascertained by the machine learning system for the video frames X₁, X₂, . . . , Xₜ₋₁, Xₜ, and at least one target segmentation frame Sₜ for a video frame Xₜ;
ascertaining a relative movement between a camera used to record the video data and the scene shown in the video frames X₁, X₂, . . . , X_{N};
ascertaining an expected segmentation frame Ŷₜ from at least one segmentation frame Yₜ₋₁ using the ascertained relative movement;
ascertaining a ground truth consistency that indicates an extent to which the actual segmentation frame Yₜ, and/or the expected segmentation frame Ŷₜ, is consistent with the target segmentation frame Sₜ for the video frame Xₜ;
for pixels or other parts of the actual segmentation frame Yₜ for which consistency exists, or for corresponding pixels or other parts of the expected segmentation frame Ŷₜ, ascertaining a temporal consistency that indicates the extent to which the pixels or other parts are consistent with corresponding pixels or other parts of the expected segmentation frame Ŷₜ, or the actual segmentation frame Yₜ; and
analyzing a desired evaluation of the machine learning system from the temporal consistency.

27. One or more computers and/or compute instances having a non-transitory machine-readable data carrier on which is stored a computer program including machine-readable instructions for evaluating a machine learning system for semantic segmentation of video data containing video frames X₁, X₂, . . . , X_{N}, wherein the semantic segmentation includes actual segmentation frames Y₁, Y₂, . . . , Yₜ₋₁, Yₜ where t N that assign pixels or other parts of each particular video frame X₁, X₂, . . . , Xₜ₋₁, Xₜ a class from a predetermined classification, the instructions, when executed on the one or more computers and/or computer instances, causing the one or more computers and/or computer instances to perform the following steps:
providing video frames X₁, X₂, . . . , Xₜ₋₁, Xₜ, segmentation frames Y₁, Y₂, . . . , Yₜ₋₁, Yₜ ascertained by the machine learning system for the video frames X₁, X₂, . . . , Xₜ₋₁, Xₜ, and at least one target segmentation frame Sₜ for a video frame Xₜ;
ascertaining a relative movement between a camera used to record the video data and the scene shown in the video frames X₁, X₂, . . . , X_{N};
ascertaining an expected segmentation frame Ŷₜ from at least one segmentation frame Yₜ₋₁ using the ascertained relative movement;
ascertaining a ground truth consistency that indicates an extent to which the actual segmentation frame Yₜ, and/or the expected segmentation frame Ŷₜ, is consistent with the target segmentation frame Sₜ for the video frame Xₜ;
for pixels or other parts of the actual segmentation frame Yₜ for which consistency exists, or for corresponding pixels or other parts of the expected segmentation frame Ŷₜ, ascertaining a temporal consistency that indicates the extent to which the pixels or other parts are consistent with corresponding pixels or other parts of the expected segmentation frame Ŷₜ, or the actual segmentation frame Yₜ; and
analyzing a desired evaluation of the machine learning system from the temporal consistency.
